(19) United States
(12) Patent Application Publication
(10) Pub. No.: US 2007/0133420 A1
(43) Pub. Date: Jun. 14, 2007

(54) Multipath routing optimization for unicast and multicast communication network traffic

(76) Inventors: Tuna Guven, Silver Spring, MD (US); Mark A. Shayman, Potomac, MD (US); Richard La, Gaithersburg, MD (US); Samrat Bhattachargee, Silver Spring, MD (US)

Correspondence Address: ROSENBERG, KLEIN & LEE, 3458 ELLICOTT CENTER DRIVE-SUITE 101, ELLICOTT CITY, MD, 21043, US

(21) Appl. No.: 11/585,155

(22) Filed: Oct. 24, 2006

Related U.S. Application Data
(60) Provisional application No. 60/729,541, filed on Oct. 24, 2005.

(51) Int. Cl. H04J 3/14

(52) U.S. Cl. 370/238

(57) ABSTRACT

Multiple paths in a communication network are provided between at least one source node and at least one destination node. The network arrangement may thus support either unicast transmission of data or multicast transmission. Measurements are made at nodes of the network to determine a partial network cost for data traversing the links in the multiple paths. An optimization procedure determines a distribution of the network traffic over the links between the at least one source node and the at least one destination node that incurs the minimum network cost.

### RELATED APPLICATION DATA

This Application is based on Provisional Patent Application Ser. No. 60/729,541, filed on 24 Oct. 2005.

### STATEMENT REGARDING FEDERALLY SPONSORED RESEARCH

The invention described herein was developed through research conducted through U.S. National Security Agency Grant MDA90402C0428. The United States Government has certain rights to the invention.

### BACKGROUND OF THE INVENTION

1. Field of the Invention

The invention described herein is related to locating a path through a switching network from a source node to at least one destination node in a communication network. More specifically, the invention distributes network traffic among links between nodes to optimize the transmission of the traffic in accordance with a cost associated therewith.

2. Description of the Prior Art

Rapid growth of telecommunications technology, specifically with regard to the Internet, and the emergence of traffic intensive telecommunications services has generated interest in telecommunication network traffic engineering. Traffic engineering pursues methodologies for evaluating network traffic performance and for optimizing underlying equipment and protocols. Traffic engineering encompasses the measurement, characterization, modeling and control of communication traffic.

Throughout the Internet's evolution from the Advanced Research Projects Agency Network (ARPANET), traditional routing techniques for Internet Protocol (IP) networks have been primarily based in path finding routines that determine the shortest path between a source node and a destination node. However, routing methods establishing only a single path between a source/destination pair often fail to utilize network resources efficiently and provide only limited flexibility for traffic engineering. Various solutions have been attempted which are derived from shortest path routing algorithms, mainly by modifying link metrics responsive to certain network dynamics. However, artifacts of these methods can result in undesirable and unanticipated traffic shifts across an entire network. Additionally, such schemes cannot distribute the load among paths in accordance with different cost metrics. These solutions also do not consider traffic/policy constraints, such as avoiding certain links for particular source/destination pairs.

Multi-Protocol Label Switching (MPLS) technology has offered new traffic engineering capabilities to overcome some of these limitations. Many schemes based on MPLS technology have been proposed, however these methods require that any existing IP infrastructure be replaced with MPLS capable devices and such overhaul poses a considerable investment for network operators.

Beginning with the early development of the Internet, information packets have been routed from a single source node to a single destination node in what has been referred to as unicast transmission of data. With the recent developments in streaming audio and video, such unicast transmission has proven insufficient to provide streaming content to many and varied users. To overcome the limitations of unicast delivery, data multicasting was developed to distribute information simultaneously to multiple users. Multicasting techniques beneficially deliver information over each link of the network only once and create copies at nodes where the links to the various destination points are split.

In IP multicast implementations, routers are provided with spanning trees that establish the distribution paths to multicast destination addresses. Unfortunately, in typical multicast systems, the tracking of what data has been sent over branches of the spanning tree requires often tremendous storage overhead. Various techniques have been developed to overcome the intensive state storage requirements associated with the IP multicast model. For example, certain encoding schemes allow packets to be transmitted in a manner that virtually avoids the need for retransmission, which then relieves much of the bookkeeping at the intermediate nodes between the source and destination. These approaches however suffer the limitations inherent in network coding solutions. First, network coding relies on an unrealistic assumption that a network is lossless as long as the average link rates do not exceed the link capacities. In fact, packet loss can be much more costly when network coding is employed, because it can potentially effect the coding of a large number of other packets. Indeed, upon occurrence of an event that changes the min-cut/max-flow value between a source and a receiver, the code must be updated at every node simultaneously, which is considerably complex and demands a high level of coordination and synchronism among nodes. Furthermore, these solutions operate under an assumption that there is only one multicast session in the network.

Overlay networks are networks that include nodes that are connected by virtual or logical links corresponding to a path in the physical network. Such overlay networks can be constructed to permit routing of datagrams through alternative nodes and not necessarily directly to the destination through the shortest path. This may be accomplished by distributed hash tables and other suitable techniques. Beneficial to Internet Service Providers (ISPs), an overlay network can be incrementally deployed at routers in the network without substantial modification to the underlying infrastructure.

With these and other developments, multicast applications have gained popularity to include Internet broadcasting, video conferencing, streaming data applications, web-content distributions, and the exchange of large data sets by geographically distributed scientists and researchers working in collaboration. Many of these applications require certain traffic rate guarantees, and providing such guarantees demands that the network be utilized in an efficient manner. Traffic mapping, or load balancing, is a particular traffic engineering technique for mitigating problems associated with assigning the traffic load onto pre-established paths to meet designated requirements. As many major ISPs continuously seek to increase their network capacity and node connectivity, which typically provides multiple paths between source/destination pairs, it is considered a goal of load balancing to better utilize the increased network resources.

Certain point-to-multipoint network solutions create multiple trees between a source and a set of destination nodes and attempt to split the traffic optimally among the trees. However, these systems optimize traffic from only a single source through a known, strictly convex and continuously differentiable analytical traffic cost function. In practice, it is difficult, if not impossible, to precisely define accurate analytical cost functions for dynamically configurable networks. Moreover, even when analytical cost functions exist, such may not be differentiable everywhere.

Given the shortcomings of the prior art, the need is apparent for a traffic engineering technique applicable to both unicast and multicast traffic within a general domain and for a practicable routing procedure for load balancing network traffic using potentially noisy network measurements as opposed to an analytical cost function.

### SUMMARY OF THE INVENTION

In one aspect of the invention, a method is provided for distributing network traffic among links in a communication network from at least one source node to a plurality of destination nodes. A cost metric characterizing the network traffic is measured on respective links in the network between the source node and the plurality of destination nodes. At the source node, a distribution of the network traffic is determined from the measured cost metric of said links so that reception of each of a plurality of datagrams by all of the plurality of destination nodes is optimal with respect to the cost metric. The datagrams are transmitted from the at least one source node to the plurality of destination nodes in accordance with the distribution.

In another aspect of the invention, a system is provided for transmitting network traffic between at least one source node and at least one destination node in a communication network. The system includes a plurality of network processors coupled one to another at nodes of the communication network for forwarding datagrams from the at least one source node to the at least one destination node. The network processors transmit an indication of transmission activity on network links coupled thereto to the source node. A processor is provided at the source node to continually stepwise adjust an amount of network traffic on respective links of the network responsive to the indication of transmission activity. The amount is adjusted in accordance with a constant step size until converging on a distribution of the network traffic among the links that minimizes a cost function of the traffic activity on the links.

In yet another aspect of the invention, a method is provided for distributing network traffic among links in a communication network from at least one source node to at least one destination node. The network traffic is transmitted from the at least one source node to the at least one destination node and a cost metric of said transmitted network traffic is measured on links of the network between the at least one source node and the at least one destination node. An amount of network traffic is adjusted on the respective links in accordance with a constant step size to form a distribution of the network traffic among the links. The adjusted network traffic is then transmitted from the at least one source node to the at least one destination node in accordance with the distribution. The network traffic cost metric on said links is re-measured and an estimate of a gradient of the cost metric responsive to the adjusted network traffic is determined therefrom. The network traffic adjusting step is repeated so as to optimize reception of the network traffic at the at least one destination node.

### BRIEF DESCRIPTION OF THE DRAWINGS

FIG. 1 is a schematic block diagram illustrating a portion of a communication network operable in accordance with the present invention;

FIG. 2 is a diagram illustrating overlay routing in accordance with aspects of the present invention;

FIGS. 3A-3C are schematic block diagrams of network models illustrating modes of operation of a communication network consistent with the present invention; and

FIG. 4 is a flow diagram illustrating certain process steps for carrying out aspects of the present invention.

### DETAILED DESCRIPTION OF PREFERRED EMBODIMENTS

The present invention provides a distributed optimal routing process that balances the network traffic load among multiple paths for multiple unicast and multicast sessions. The invention operates on network traffic measurements and does not assume the existence of the gradient of an analytical cost function. The present invention addresses optimal multipath routing with multiple multicast sessions in a distributed manner while relying only on local network measurements.

Generally, the present invention may be implemented in a network that includes a set of unidirectional links [symbol] ={1, . . . , L} and a set of source nodes [symbol] ={1, . . . , S}. Each source node may be associated with either one of a unicast or a multicast session. A set of destination nodes D^{s} is associated with each source node sε [symbol] . Each source node must deliver packets to every destination dεD^{s} at a rate r^{s}. The present invention distributes the network traffic originating from the source node among a plurality of paths to the destination nodes as opposed to relying on a default shortest routing path selected by the underlying routing protocol. The alternative paths may be implemented by, for example, a set of application layer overlay nodes installed throughout the network.

Referring to FIG. 1, there is shown a portion of a network architecture consistent with the present invention. The exemplary network includes a plurality of network nodes 105, 110a, 110b, 120m, 120n, 125a and 125b interconnected through a plurality of network links 130a-130i. For simplifying the description of aspects of the invention, the view of FIG. 1 depicts a single source node 105 and two destination nodes 125a, 125b. However, it is to be understood that the network may include multiple source nodes, as well as many more destination nodes, operating concurrently in accordance with the invention.

In certain embodiments of the invention, the network includes a plurality of application-layer overlay nodes 110a, 110b, which may be end hosts located in possibly different cooperating administrative domains. The overlay nodes 110a, 110b may be implemented in a router or in an end host network appliance, either provided with a network processor 115a, 115b. A network router embodying an overlay node will be referred to herein as a “core” overlay node, such as that illustrated at 110a, 110b, and an end host appliance embodying an overlay node will be referred to herein as an “edge” overlay node, such as that illustrated at 105.

The exemplary network architecture includes nodes 120n, 120m having routers 122n, 122m, respectively, for forwarding network traffic by either a unicast session or a multicast session, as will be described further below. Similarly, the overlay nodes 110a, 110b may be configured to forward packets in either of a multicast session or a unicast session.

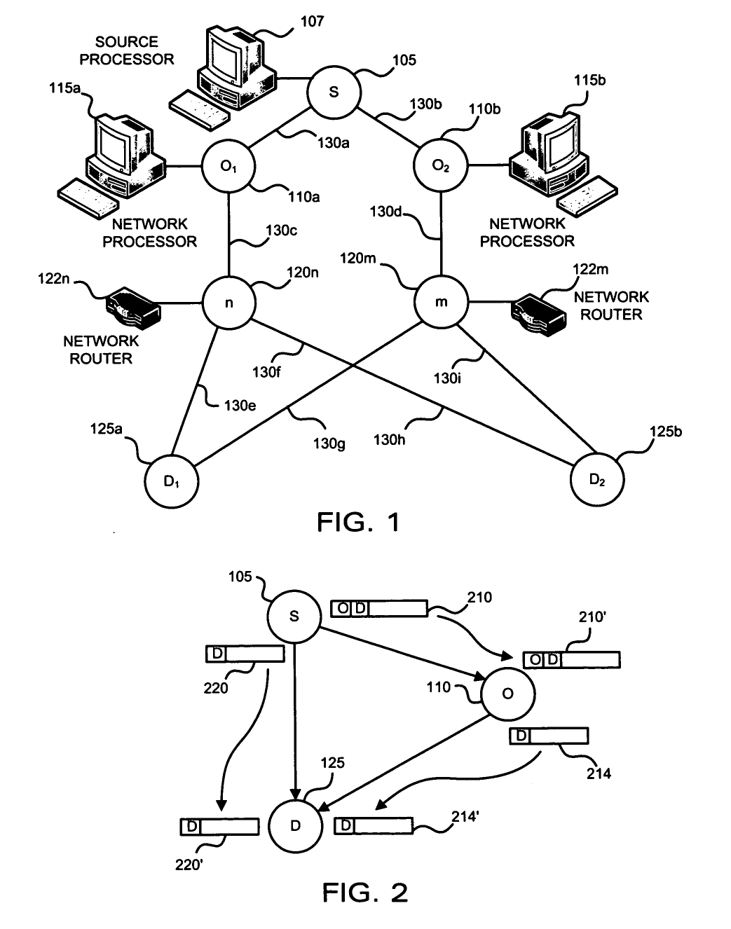

The present invention implements load balancing procedures to utilize multiple paths between source and destination nodes and to optimize the network performance in accordance with a chosen network cost function. The paths may be selected by way of the overlay network, as will now be described with reference to FIG. 2. Processes executing on, for example, source node processor 107 at source node 105 may create an alternate path to a destination node 125 by attaching an additional header to the packet 210 with the IP address of the selected overlay node 10 as the destination address. When the packet arrives at the overlay node 110, as shown at 210′, it may strip the packet of the extra IP header by way of an application executing on network processor 115, as shown at packet 214. The overlay node 110 forwards the packet to the destination node 125, as shown at 214′, utilizing the underlying routing protocol. This path is an alternative to that which would have been selected by the IP protocol, i.e., addressed packet 220 directly addressed to destination node 125 via the shortest path, where it would have been received as packet 220′.

The alternative routing technique described above may be viewed as a form of loose source routing in the sense that the source node can exercise a certain level of route selection for individual packets. In accordance with the exemplary embodiment of the present invention, a source node can forward any fraction of packets to a destination node through any of the available core overlay nodes, creating multiple paths to the destination node. Such technique does not require any change to the underlying IP routing protocol in that the packet forwarding may be achieved by application layer processes.

It is to be understood that the overlay network may be excluded for purposes of implementing the invention if the communications network is provided with a routing scheme that allows the source node to distribute packets among multiple various paths and allows the source node to select what fraction of its packets are to be routed among the multiple selected paths. For example, the invention may be implemented in a Multiprotocol Label Switching (MPLS) based network, where the overlay nodes are replaced with Label Switched Paths (LSPs). The overlay network allows the present invention to be implemented on IP networks, which is the exemplary network used herein for purposes of description.

The set of core overlay nodes will be denoted herein by [symbol] and the set of overlay nodes in [symbol] used to create alternative paths between a source sε [symbol] and its destination node(s) D^{s} will be denoted by O_{c}^{s}⊂ [symbol] . In certain embodiments of the invention, every source node is also an edge overlay node, and as such, the set of overlay nodes utilized by a source sε [symbol] is given by O^{s}:=O_{c}^{s}∪{s}, and there are Nₛ:=|O^{s}| paths available to each destination node, where |O^{s}| denotes the cardinality of O^{s}.

In prior art multicast systems, when a source s forwards packets to a destination d, the source must maintain careful bookkeeping of all the packets forwarded to each receiver so that every packet is forwarded to each receiver and delivery of duplicate packets is minimized. For the same reasons, an intermediate IP router must be able to identify the set of intended receivers for each packet in a multicast scenario. Thus, when different sets of packets are forwarded to different destinations using two or more overlay nodes, the source must keep track of the packets forwarded along different paths so that every destination receives all necessary packets. This complicated bookkeeping must occur at both the multicast source nodes and the core overlay nodes. To avoid this bookkeeping requirement, certain embodiments of the present invention employ source coding to ensure the destination receives all distinct packets necessary to recover the message.

The Internet, as well as other communication networks, can be modeled as an erasure channel and certain embodiments of the invention apply an erasure-correcting code to eliminate retransmission of dropped packets. Traditional block codes for erasure correction include Reed-Solomon codes, which have the property that if any K of N transmitted symbols are received, then the original K source symbols can be recovered. However, when using a Reed-Solomon code, as with any block code, one must estimate the erasure probability and choose the code rate before transmission. Moreover, Reed-Solomon codes are practical only for small K, N.

Erasure codes have been developed that are rateless in the sense that the number of encoded packets that can be generated from a source message is potentially limitless. That is to say, the number of encoded packets to generate for a given source message can be determined at the time of encoding. Then, regardless of the statistics of the erasure events on the channel, one can send as many encoded packets as needed in order for the encoder to recover the source data. The input and output symbols can be bits, or are more generally binary vectors of arbitrary length. Each output symbol may be generated by a binary addition of some arbitrarily selected input symbols. The number of input symbols to be added is determined according to some fixed degree distribution. Each output symbol may be tagged with information describing which input symbols are used to generate it, for example, in the packet header. Rateless erasure code technology is readily available, such as those developed by Digital Fountain, Inc, which will be referred to herein as Fountain codes.

Using Fountain codes, the original K input symbols from any set of M output symbols may be recovered with high probability. A preferable Fountain code implementation selects the value of M that is very close to K, in which case the decoding time is approximately linear in K. “Raptor” codes are Fountain codes that allow for linear time encoders and decoders, for which the probability of a decoding failure converges to zero polynomially fast in the number of input symbols. For example for K=64,536 and M=65,552, i.e., a redundancy of 1.5%, the error probability is upper bounded at 1.71×10⁻¹⁴. In practice, most Digital Fountain codes introduce approximately 5% operational overhead to implement.

In certain embodiments of the invention, a source node first divides the network communication traffic into blocks of K symbols and applies a Fountain code, e.g., a Raptor code, or a similar rateless erasure code to generate encoded output symbols that are forwarded to the destinations. The block size may be constrained by the buffer size at the source. Since a receiver can then recover the K source symbols in each block from any M encoded symbols, the source node does not require any bookkeeping as long as it sends distinct packets along each path. This will guarantee that each receiver successfully receives the whole data stream as long as each user receives packets at a sufficient rate. Thus, the invention assigns packet forwarding rates on available paths for each destination subject to a constraint that the aggregate rate at which the destination receives packets exceeds some predetermined threshold, which depends on the demand rate r^{s} as well as the efficiency of the coding scheme.

The network architecture depicted in FIG. 1 subsumes several network traffic models, all of which are operable in accordance with the present invention. In each model described below, for each sε [symbol] and dεD^{s}, the rate at which the source node s sends packets to destination d through overlay node oεO^{s} is denoted by x_{o,d}^{s}. Also, the total rate at which an overlay node o receives packets from source s is denoted by xₒ^{s}. In a unicast scenario, this is simply the rate at which packets are forwarded to the destination through the overlay node, while in the case of a multicast session, the underlying network prescribes the rate, as will be explained in the paragraphs that follow.

As previously described, the adoption of a rateless erasure code allows the invention to generalize a rate assignment of x=(x_{o,d}^{s}, sε [symbol] , oεO^{s}, dεD^{s}). The overlay nodes are allowed, in certain embodiments, to copy packets and hence the sources need only to deliver a single copy of any packet to an overlay node and the overlay node then acts as a surrogate source for those packets. In such an embodiment, the rate xₒ^{s} to an overlay node o is given by xₒ^{s}=max_{dεD}_{^{s}} x_{o,d}^{s} and, depending on the network model and the assigned rates, some or all of the packets are forwarded to the overlay node and relayed to their destinations.

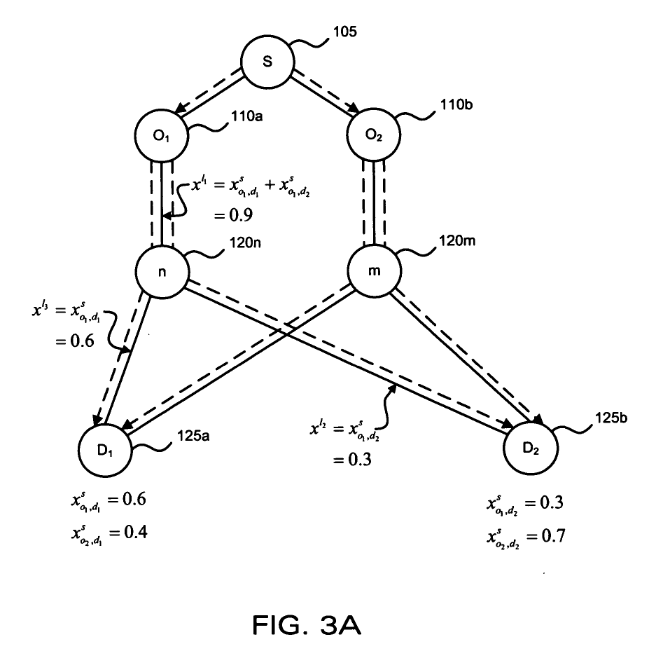

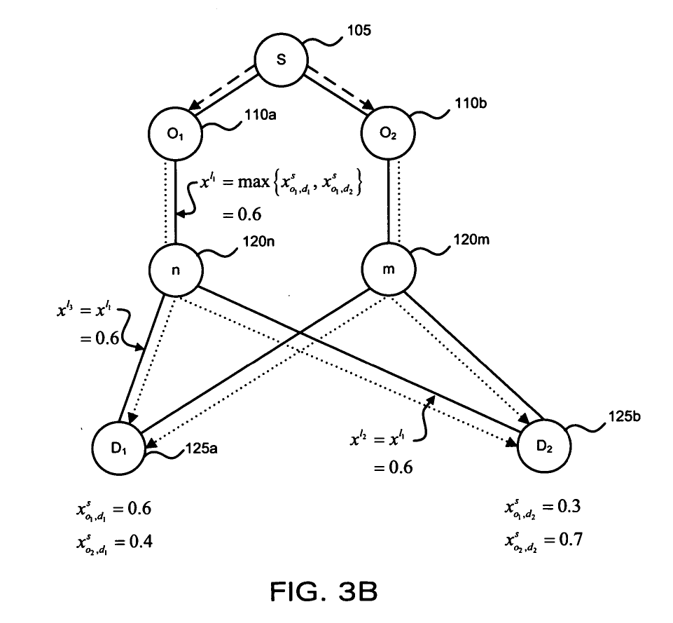

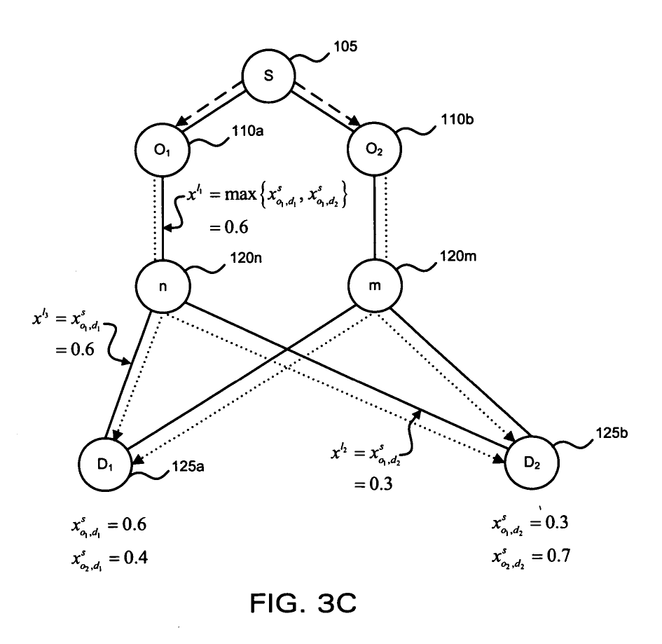

The models will now be described with reference to FIGS. 3A-3C, where like reference numerals to those of FIG. 1 refer to like elements. In FIG. 3A, a network model is depicted in which only unicast traffic is present and the routers at nodes 120n, 120m do not possess IP multicast functionality. Packets from the source node 105 are encoded using a rateless erasure code, such as the Digital Fountain code previously described. The source node 105 first forwards the encoded packets to overlay nodes 110a, 110b at the required rate and the overlay nodes 110a, 110b create a unicast session for each destination, as represented by the dashed line in the Figure. The overlay nodes forward packets at a rate x_{o,d}^{s}. The source node 105 and the overlay nodes 110a, 110b maintain multiple unicast sessions to implement a session with more than one destination.

If Vₙ_{₂}ⁿ^{₁}⊂ [symbol] is the set of links in the default path for node n₁ to n₂, then given a rate assignment x, the link load x^{l}, lε [symbol] is given by

$${x}^{l} = {\sum }_{s ∈ S} ( {\sum }_{o ∈ {O}_{c}^{s} \text{:} l ∈ {V}_{o}^{s}} {x}_{o}^{s} + {\sum }_{o ∈ {O}^{s}} ( {\sum }_{d ∈ {D}^{s} \text{:} l ∈ {V}_{d}^{o}} {x}_{o , d}^{s} ) ) . \qquad ( 1 )$$

Numerical examples of link loads are shown in the Figure. This multipath unicast model will be referred to herein as NM-I.

In FIG. 3B, the routers at nodes 120n, 120m, and those at overlay nodes 110a, 110b are IP multicast capable, where the multicast sessions are indicated by the dotted lines. Each overlay node oεO^{s} creates a separate multicast tree [symbol] ₒ^{s} rooted at itself for forwarding packets from the source s using an intradomain multicast procedure, such as the Distance Vector Multicast Routing Protocol (DVMRP). In a unicast session, [symbol] ₒ^{s} denotes the set of links along the default path from the overlay node o to the destination. However, the IP multicast routers are considered to be only capable of copying and forwarding packets. Hence, every packet forwarded to an overlay node by a source node s is relayed to all destinations in D^{s}. As a result, the rate at which destination nodes receive packets from an overlay node is the same, assuming no packet losses, and is given by xₒ^{s}=max_{dεD}_{^{s}} x_{o,d}^{s}. Clearly, this may cause a receiver to receive packets at a rate larger than intended. However, embodiments of the present invention exploit this property through measurements and eliminate such redundancy. In fact, at the optimal operating point x*, x_{o,d}^{s}*=xₒ^{s}*, for all dεD^{s}.

In the scenario of FIG. 3B, the load of link l is:

$${x}^{l} = {\sum }_{s ∈ S} ( {\sum }_{o ∈ {O}_{c}^{s} \text{:} l ∈ {V}_{o}^{s}} {x}_{o}^{s} + {\sum }_{o ∈ {O}^{s} \text{:} l ∈ {T}_{o}^{s}} {x}_{o}^{s} ) , \qquad ( 2 )$$

where Tₒ^{s} is the set of links in the multicast tree [symbol] ₒ^{s}. This model will be referred to as NM-II.

In the model of FIG. 3C, referred to herein as NM-III, the IP multicast capability of the routers is enhanced to allow forwarding packets onto each branch of the tree at a different rate. As used herein, such routers will be referred to as “smart” routers to distinguish them from the routers of NM-II. Under this model, a source s can select the individual rates x_{o,d}^{s} independently for each destination and packets will be forwarded to a destination dεD^{s} at the intended rate x_{o,d}^{s} as opposed to max_{dεD}_{^{s}} x_{o,d}^{s} of the NM-II model. This additional rate control allows a network operator more flexibility and fine-grained control of the rate assignment and to better exploit the existence of multiple paths through overlay nodes.

The link rates under the NM-III model are given by:

$${x}^{l} = {\sum }_{s ∈ S} ( {\sum }_{o ∈ {O}_{c}^{s} \text{:} l ∈ {V}_{o}^{s}} {x}_{o}^{s} + {\sum }_{o ∈ {O}^{s}} {max}_{d ∈ {D}^{s} \text{:} l ∈ {\hat{V}}_{d}^{a}} {x}_{o , d}^{s} ) . \qquad ( 3 )$$

Here \hat{V}_{d}^{o} denotes the set of links along the path from the overlay node o to destination d. In the case of a multicast session, this is the set of links in the multicast tree which may be different from the default path provided by the underlying routed protocol.

In all of the scenarios of NM-I, NM-II and NM-III, overlay nodes 110a, 110b may be viewed as content delivery servers that store a portion of the original content to be distributed. It is an object of the invention to provide a unified load balancing process that minimizes the total network cost by distributing the traffic load among multiple available paths under all three network models. Of course, the link loads are dependent on the network capabilities and, thus, the desired operating point, as well as the aggregate network cost, is determined by the appropriate network model. However, the benefits of the invention are achieved in all three of these scenarios, as well as others.

The rate assignment may be considered an optimization problem, where the objective function as the sum of link costs. A link cost may be a function of the total rate traversing a particular link x^{l} and is given by Cₗ(x^{l}), lε [symbol] . The link cost functions need not be differentiable, but are preferably convex. The optimization problem may then be stated as:

$$\begin{matrix}{min}_{x} C ( x ) = {\sum }_{l ∈ L} {C}_{l} ( {x}^{l} ) & ( 4 ) \\ s . t . {\sum }_{o ∈ {O}^{s}} {x}_{o , d}^{s} = {r}^{s} + {ɛ}^{s} , ∀ s ∈ S , d ∈ {D}^{s} & ( 5 ) \\ {x}_{o , d}^{s} \geq v , ∀ s ∈ S , o ∈ {O}^{s} , d ∈ {D}^{s} , & ( 6 )\end{matrix}$$

where r^{s} is the assumed traffic rate of source s, v is an arbitrarily small positive constant and ε^{s} is the additional rate required by the coding scheme for a receiver to successfully decode the incoming encoded data.

The cost optimization of Eq. (4) may be solved using a Stochastic Approximation (SA) technique. As is known, SA is a recursive procedure for finding the root(s) of equations using noisy measurements and is useful for finding extrema of certain functions. The general constrained SA is similar to well known gradient projection in which, at each iteration k=0, 1, . . . , of the procedure, the variables are updated based on the gradient. In SA, however, the gradient vector ∇C(k) is replaced by its approximation ĝ(k). The approximation is often obtained through measurements of the cost C(k) around x(k). Under appropriate conditions, x(k) can to almost surely converge to a solution of Eq. (4).

Another particular method for gradient estimation is referred to as Simultaneous Perturbation (SP). When SP is employed, all elements of x(k) are randomly perturbed simultaneously to obtain two measurements, y(x(k)+ξ(k)Δ(k)) and y(x(k)−ξ(k)Δ(k)). Here, ξ(k) is some positive scalar and Δ(k)=(Δ₁(k), . . . , Δₘ(k)) is a random perturbation vector generated by the SP method and must satisfy certain conditions. The i^{th} component of the gradient approximation ĝ(k) may be computed from these two measurements according to

$${\hat{g}}_{s , i} ( k ) = \frac{y ( x ( k ) + ξ ( k ) Δ ( k ) ) - y ( x ( k ) - ξ ( k ) Δ ( k ) )}{2 ξ ( k ) {Δ}_{i} ( k )} , \\ i = 1 , … , m . \qquad ( 7 )$$

SA methods that use SP for gradient estimation are referred to as Simultaneous Perturbation Stochastic Approximation (SPSA). SPSA has significant advantages over SA algorithms that employ traditional gradient estimation methods, such as Finite Difference (FD).

It is to be noted that in the optimization problem of Eqs. (4)-(6), the decision variable x is a collection of rate assignments of the sources x^{s}, sε [symbol] and the constraints given in Eqs. (5) and (6) comprise separate constraints for each source that are independent of others. Therefore, the problem can be naturally decomposed into several coupled sub-problems, one for each source.

For purposes of description, the symbol Θₛ will denote the set of feasible rate assignments for source s that satisfy the constraints of Eqs. (5)-(6) and Π_{Θ}[ζ] denotes the projection of a vector ζ onto the feasible set Θₛ using a Euclidean norm. The set of links utilized by source s's packets will be denoted as L^{s}. The makeup of the set L^{s} is dependent on the network model and is given as {Vₒ^{s}∪V_{d}^{o}:oεO^{s}, dεD^{s}} for NM-I and {Vₒ^{s}∪Tₒ^{s}:oεO^{s}} for NM-II and NM-III.

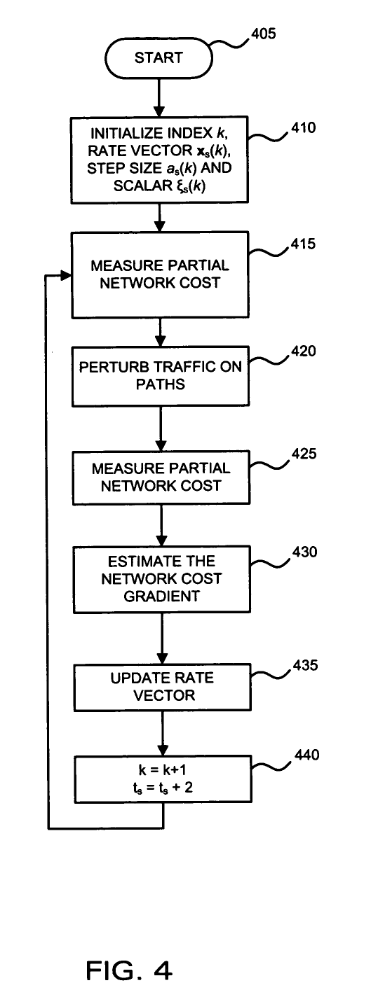

In certain embodiments of the invention, an SPSA-based process is executed at each source node on, for example, a processing unit, in a distributed manner, as is shown in FIG. 4. The process is entered at step 405, whereby flow is transferred to block 410 in which an index variable k, rate assignment vector xₛ(k), a step size aₛ(k) and scalars ξₛ(k) are initialized for each source node sε [symbol] . Flow is then transferred to block 415, where the partial network cost is measured for the time period (tₛ, tₛ+1), where tₛ is the measurement time at a particular node s, i.e., the source nodes may execute the respective measurements in accordance with independent time scales. The partial network cost for the time period (tₛ, tₛ+1) is given by:

$${y}_{s} ( x ( k ) ) = {\sum }_{l ∈ {L}^{s}} {C}_{l} ( {x}^{l} ) + {μ}_{s}^{-} ( k ) , \qquad ( 8 )$$

where μₛ⁻(k) is a measurement noise term to account for stochastic network traffic behavior and/or lack of synchronism in the execution of the optimization process at different source nodes. The measurement described by Eq. (8) may be made by the overlay architecture. Each link in the network may be mapped to the closest overlay node, possibly with a tiebreaking rule to give a unique mapping. Overlay nodes periodically poll the links for which they are responsible, process characterizing data, such as traffic flow rate, and forward the state information to the source/destination pairs utilizing the corresponding links. This eliminates the need for each source/destination pair to probe its links. It is to be noted that before forwarding the link cost information to the source nodes of the source/destination pairs, the overlay nodes can aggregate information gathered from different links. For example, if the overlay nodes are aware of the complete set of links belonging to a source node, an overlay node can first compute the sum of the link cost over the links in the set and then report the total cost for that set to the source node of the source/destination pair. Other techniques are possible to provide the source node with the corresponding cost information measurement and the scope of the invention is not limited by the implementation of the measurement collection and reporting process.

Flow is transferred to block 420 in which, at time tₛ+1, the distribution of traffic on each of the paths is perturbed in accordance with:
xₛ(k)=Π_{Θ}(xₛ(k)+ξₛ(k)Δₛ(k)). (9)
Then, at block 425, another partial network cost measurement is made in the time period (tₛ+1, tₛ+2) according to:

$${y}_{s} ( {\prod }_{Θ} [ x ( k ) + Ξ ( k ) Δ ( k ) ] ) = {\sum }_{l ∈ {L}^{s}} {C}_{l} ( {x}^{l} ) + {μ}_{s}^{+} , \qquad ( 10 )$$

where Δ(k)=(Δₛ(k), sε [symbol] ) is a N×1 vector, Δₛ (k) is the random perturbation vector generated by source s at iteration k, Ξ(k) is an N×N diagonal matrix composed of block diagonal entries {Ξₛ(k): ξₛ(k)·Iₛ, sε [symbol] } with ξₛ(k)>0, Iₛ is a (Nₛ·|D^{s}|)×(Nₛ·|D^{s}|) identity matrix and

$$N = {\sum }_{s ∈ S} ( {N}_{s} \times \vert {D}^{s} \vert ) .$$

The variable μₛ⁺ denotes a measurement error term similar to μₛ⁻(k). Flow is then transferred to block 430, wherein the gradient of the network cost is estimated. If the cost function C₁(k) is known and is differentiable, the actual gradient ∇Cₛ(k)=(∂C(x(k))/∂x_{o,d}^{s}, oεO^{s},dεD^{s}) may be computed by a suitable processor at the source node. However, if the cost function is not differentiable, an estimation of the gradient may be evaluated by:

$$\begin{matrix}{\hat{g}}_{s , i} ( k ) = \frac{{N}_{s}}{{N}_{s} - 1} \frac{{y}_{s} ( {\prod }_{Θ} [ x ( k ) + Ξ ( k ) Δ ( k ) ] ) - {y}_{s} ( x ( k ) )}{{ξ}_{s} ( k ) {Δ}_{s , i} ( k )} \\ = \frac{{N}_{s}}{{N}_{s} - 1} \frac{( {C}_{s}^{+} + {μ}_{s}^{+} ( k ) ) - ( {C}_{s}^{-} ( k ) + {μ}_{s}^{-} ( k ) )}{{ξ}_{s} ( k ) {Δ}_{s , i} ( k )}\end{matrix} \\ i = 1 , … , {N}_{s} \cdot \vert {D}^{s} \vert , \qquad ( 11 )$$

where yₛ(x) is the noisy measurements of the partial network cost

$${Λ}_{s} ( x ) := {\sum }_{l ∈ {L}^{s}} {C}_{l} ( {x}^{l} )$$

obtained with a given rate assignment vector x, Cₛ⁻(k) and Cₛ⁺(k) are Λₛ(x(k)) and Λₛ(Π_{Θ}[x(k)+Ξ(k)Δ(k)]), respectively. The process proceeds to block 435 where at time tₛ+2, the rate vector is updated according to:
xₛ(k+1)=Π_{Θ}[xₛ(k)−aₛ(k)ĝ(k)], (12)
where aₛ(k)>0 is the step size, which is described further below. Flow is transferred then to block 440, where the index k is incremented and the time index is set tₛ=tₛ+2 and flow is transferred back up to 415, where the process is repeated.

The process of FIG. 4 will continue to execute and will eventually converge on, or approximately converge on, as will be explained below, a rate vector x that distributes the network traffic across the links to the destination or destinations with a minimal cost. The source will continue to draw a new perturbation vector until Π_{Θ}[xₛ(k)+ξₛ(k)Δₛ(k)]≠xₛ(k).

The computations of Eqs. (8)-(12) are easily programmed by a skilled artisan into processing instructions executable on a suitable computing platform, such as a microprocessor. Such microprocessor may be part of a network processor, such as shown at 107 in FIG. 1 or may be embedded in another networked device.

The present invention provides several benefits over the standard SPSA algorithm. First, the gradient approximation in Eq. (11) defers from the standard SA; each source uses only partial cost information, i.e., the summation of the cost of the links in L^{s}, as opposed to the total network cost which is the summation of the cost of all the links in the network. Thus, the communication overhead stemming from the exchange of link cost information to the sources is minimized. In addition, the noise terms observed by the sources are allowed to be different. Second, while ξ(k) is a positive scalar in the standard SA, the present invention utilizes an N×N diagonal matrix Ξ(k). This allows the possibility of having different ξₛ(k) values at different sources. Third, there is an extra multiplicative factor Nₛ/(Nₛ−1) in Eq. (11) when compared to the standard SA. This is due to the projection of the perturbed rate vector xₛ(k)+ξₛ(k)Δₛ (k) onto the feasible set Θₛ for all sε [symbol] using a L₂ projection when calculating ĝₛ (k).

In certain embodiments of the invention, the sources update their rate vectors once at every iteration once they have started the procedure. Such embodiments ensure utilization of the collected measurement information for each iteration at each source. However, the updating of the rate vectors need not be simultaneous at all sources. The errors due to the lack of synchronization are accounted for in the measurement error terms μₛ^{±}(k).

The present invention does not require that the sources have the same step size aₛ(k) at each iteration. This permits a certain level of asynchronous operation among the sources. For example, a scenario may exist where the sources start the inventive process at different times and still converge on a solution for all involved links.

The rate vector update may be controlled by a step size factor {aₛ(k), k=1, 2, . . . }, which may in certain embodiments be a constant factor or may decrease with each iteration. The invention converges to an optimal rate assignment using the decreasing step size embodiment, however, once the convergence has occurred, responding to sudden changes in the network traffic may occur only slowly. When such changes do occur, the step size must be reset to an initial value and the process restarted. This requires an additional mechanism and decision process to monitor the network for any significant change and to reset the step sizes at the sources when necessary.

In certain embodiments of the invention, a constant step size may be preferred to avoid the slow recovery of the decreasing step size process. When the step sizes at the sources are fixed, i.e., aₛ(k)=a for all sε [symbol] and k=0, 1, . . . , the convergence to an optimal rate assignment is not assured. However, under certain circumstances, the constant step size may achieve weak convergence to a neighborhood of the solution set. Since the performance near the set of solutions is comparable to that of a solution, a constant step size policy performs reasonably well and avoids the problems associated with the decreasing step size and a sudden state change.

It is to be noted that the present invention does not require any modification for the convergence for any of the different network models. This allows the underlying IP network to be gradually upgraded without requiring any changes to the process.

In certain embodiments, a multicast source node may avoid using a rateless erasure code, in which case special care must be afforded while splitting the traffic at the source node to avoid the well known reordering problem, especially for TCP traffic. The present invention calculates the rates at which traffic should be distributed among the alternative paths without requiring or specifying the exact paths that a particular packet should follow. Therefore, certain embodiments include a suitable filtering scheme that minimizes the reordering problem.

The descriptions above are intended to illustrate possible implementations of the present invention and are not restrictive. Many variations, modifications and alternatives will become apparent to the skilled artisan upon review of this disclosure. For example, components equivalent to those shown and described may be substituted therefor, elements and methods individually described may be combined, and elements described as discrete may be distributed across many components. The scope of the invention should therefore be determined not with reference to the description above, but with reference to the appended Claims, along with their full range of equivalents.

What is claimed is:

1. A method for distributing network traffic among links in a communication network from at least one source node to a plurality of destination nodes, the method comprising:
measuring a cost metric characterizing the network traffic on respective links in the network between the source node and the plurality of destination nodes;
determining at the source node from said measured cost metric of said links a distribution of the network traffic among said links so that reception of each of a plurality of datagrams by all of the plurality of destination nodes is optimal with respect to said cost metric; and
transmitting said datagrams from the at least one source node to the plurality of destination nodes in accordance with said distribution.

2. The method for distributing network traffic as recited in claim 1, where the distribution determining step includes the steps of:
adjusting an amount of network traffic on said respective links in accordance with a step size to form a distribution of the network traffic among said links;
re-measuring said network traffic cost metric on said links and determining therefrom an estimate of a gradient of said cost metric responsive to said adjusted network traffic; and
repeating said network traffic amount adjusting step and said network traffic cost metric re-measuring step until convergence on said distribution is attained.

3. The method for distributing network traffic as recited in claim 2, where the network traffic amount adjusting step includes the step of adjusting said amount of the network traffic on at least one of said links by an amount that is not equal to said amount of the network traffic adjusted on another of said links.

4. The method for distributing network traffic as recited in claim 2, where the network traffic amount adjusting step includes the step of adjusting in accordance with said step size being constant in every repeated network traffic amount adjusting step.

5. The method for distributing network traffic as recited in claim 2, where the network traffic amount adjusting step includes the step of adjusting in accordance with said step size decreasing in every repeated network traffic amount adjusting step.

6. The method for distributing network traffic as recited in claim 5 further including the step of resetting said step size to an initial value upon detecting a predetermined change in an amount of the network traffic.

7. The method for distributing network traffic as recited in claim 1 further including the step of encoding said datagrams with a rateless erasure code such that each of said datagrams on each of said links is distinct from other of said datagrams on other of said links.

8. The method for distributing network traffic as recited in claim 1, where said datagram transmitting step includes the step of transmitting said plurality of datagrams from the at least one source node to the plurality of destination nodes in accordance with said distribution such that a rate at which said datagrams are forwarded to each of the plurality destination nodes is independent of said rate at which said datagrams are forwarded to other of the plurality of destination nodes.

9. A system for transmitting network traffic between at least one source node and at least one destination node in a communication network comprising:
a plurality of network processors coupled one to another at nodes of the communication network for forwarding datagrams from the at least one source node to the at least one destination node, said network processors transmitting to said source node an indication of transmission activity on network links coupled thereto;
a processor at said source node continually stepwise adjusting an amount of network traffic on respective links of the network responsive to said indication of transmission activity, said amount being adjusted in accordance with a constant step size until converging on a distribution of the network traffic among said links that minimizes a cost function of said traffic activity on said links.

10. The system for transmitting network traffic as recited in claim 9, wherein said source node processor executes computer instruction steps implementing a simultaneous perturbation stochastic approximation process to converge on said distribution of the network traffic.

11. The system for transmitting network traffic as recited in claim 9, wherein a set of said network processors include a network application layer process executing thereon for routing said datagrams to the at least one destination node through a set of said nodes other than a set of nodes selected in accordance with a routing protocol of the communication network.

12. The system for transmitting network traffic as recited in claim 11, wherein said routing protocol is compliant with Internet Protocol standards.

13. The system for transmitting network traffic as recited in claim 9, wherein said network processors forward said datagrams to the at least one destination node in accordance with Multi-Protocol Label Switching standards.

14. The system for transmitting network traffic as recited in claim 9 further including an encoder at said source node processor for encoding said datagrams with a rateless erasure code.

15. The system for transmitting network traffic as recited in claim 9, wherein a set of said network processors include routers forwarding said datagrams from the at least one source node to a plurality of the destination nodes in accordance with said distribution such that a rate at which said datagrams are forwarded to each of said plurality of destination nodes is independent of said rate at which said datagrams are forwarded to other of said plurality of destination nodes.

16. A method for distributing network traffic among links in a communication network from at least one source node to at least one destination node, the method comprising:
transmitting the network traffic from the at least one source node to the at least one destination node;
measuring a cost metric of said transmitted network traffic on links of the network between the at least one source node and the at least one destination node;
adjusting an amount of network traffic on said respective links in accordance with a constant step size to form a distribution of the network traffic among said links;
transmitting said adjusted network traffic from the at least one source node to the at least one destination node in accordance with said distribution;
re-measuring said network traffic cost metric on said links and determining therefrom an estimate of a gradient of said cost metric responsive to said adjusted network traffic; and
repeating at said network traffic adjusting step so as to optimize reception of the network traffic at the at least one destination node.

17. The method for distributing network traffic as recited in claim 16, where the network traffic amount adjusting step includes the step of adjusting said amount of the network traffic on at least one of said links by an amount that is not equal to said amount of the network traffic adjusted on another of said links.

18. The method for distributing network traffic as recited in claim 16 further including the step of encoding packets of the network traffic with a rateless erasure code such that each of said packets on each of said links is distinct from other of said packets on other of said links.

19. The method for distributing network traffic as recited in claim 16 including the step of filtering the network traffic so arrival thereof at the at least one destination node is in accordance with a predetermined order.

20. The method for distributing network traffic as recited in claim 16 where said adjusted network traffic transmitting step includes the step of transmitting the network traffic from the at least one source node to a plurality of the destination nodes in accordance with said distribution such that a rate at which the network traffic is forwarded to each of the plurality destination nodes is independent of said rate at which the network traffic is forwarded to other of the plurality of destination nodes.
